(19) United States
(12) Patent Application Publication
(10) Pub. No.: US 2006/0261303 A1
(43) Pub. Date: Nov. 23, 2006

(54) Throttle valve

(75) Inventors: Andrew Donald Thomas, North Epping (AU); Mark Silvio Profaca, West Pymble (AU)

Correspondence Address: BIRCH STEWART KOLASCH & BIRCH, PO BOX 747, FALLS CHURCH, VA, 22040-0747, US

(73) Assignee: Bishop Innovation Limited, North Ryde (AU)

(21) Appl. No.: 10/553,057

(22) PCT Filed: Apr. 29, 2004
(86) PCT No.: PCT/AU04/00548

§ 371 Date: Jun. 28, 2006

(30) Foreign Application Priority Data
May 1, 2003 (AU) 2003902065
Nov. 3, 2003 (AU) 2003906061

(51) Int. Cl. F16K 3/00

(52) U.S. Cl. 251/212

(57) ABSTRACT

A throttle valve (1) for an inlet of an internal combustion piston engine comprising an aperture (9) adapted to be variably opened and closed between a first fully opened configuration and a second near closed configuration. The aperture (9) is variably opened and closed by a plurality of coplanar plates (10) mounted about the periphery of the aperture and movable towards the central region of the aperture.

### TECHNICAL FIELD

The present invention relates to a throttle valve for the air/fuel intake of an internal combustion piston engine. The present invention is described with reference to a rotary valve internal combustion piston engine, however, it should be understood that the present invention is suitable for use with any internal combustion piston engine that requires a throttle valve.

### BACKGROUND

The majority of vehicle internal combustion piston engines utilise a butterfly throttle valve to control air/fuel intake. Whilst butterfly throttle valves are of a relatively simple and inexpensive design, they have a number of disadvantages. Firstly, when a butterfly throttle valve is fully open, i.e., at full throttle, the butterfly plate still restricts the fluid flow. This restriction at full throttle impedes engine performance, where the drag of the fully open butterfly plate, impedes the fluid flow entering the engine.

Another disadvantage of a butterfly throttle valve is its length. Butterfly throttle valves are not suitable for placement very close to the cylinder intake, because the butterfly plate will interfere with the inlet port valve, as well as misdirect the fluid flow as it enters the inlet port of the cylinder. This is most disadvantageous on a high performance engine, where the placement of the throttle valve as close as possible to the inlet port is critical to maximise engine performance at higher engine speeds. This is because the overall length between the cylinder intake and the air intake is critical to the performance of engines operating at high speeds. Where the length between the cylinder and air intake is reduced, the engine may be run at higher speeds more efficiently.

Slide (or guillotine) throttle valves are also common place on many high performance motorcycle engines and provide an unobstructed flow to the inlet of the cylinder when at fully open throttle. As the relative length of slide throttle valves is smaller to than that of butterfly throttle valves, they can be used in configurations where it is desirable to minimise the length between the cylinder intake and the air intake. However, the main disadvantage to this type of throttle valve is space surrounding the valve aperture. Slide throttle valves occupy a substantial area surrounding the valve aperture to allow for the throttle plate to fully withdraw. Also, slide throttle valves are prone to bind or seize and may require extra maintenance.

GB2292416 (Lambda) describes a throttle valve for an internal combustion engine. This throttle valve is an “iris diaphragm” type, which is used to control the amount of airflow into a carburettor. An iris diaphragm valve utilises concentrically mounted overlapping plates that pivot inwardly and outwardly, as shown in FIG. 3 of GB 2292416, to vary the diameter of a centrally disposed aperture, thereby creating throttling action. Throttling is only accomplished over the air flow into the carburettor, with fuel entering via another path having another throttling means operating simultaneously. Whilst this type of valve is more suited to throttle air only, it is not suitable for air/fuel mixtures as the overlapping plates are prone to binding or seizure.

Similarly, GB937626 (Greene) describes an improved carburettor that utilises a conventional iris diaphragm valve. Although its action and construction are not clearly described or shown, FIGS. 5 to 9 clearly show a conventional type iris diaphragm similar to GB2292416.

AU12321/33 (Henrich) and AU10430/22 (D'arcy) also mention specify iris diaphragm valves in their inventions and although the constructions of these valves are also not described, the requirements of these inventions dictate conventional iris diaphragm valves, with varying diameter apertures, are employed.

Whilst conventional “iris diaphragm” valves of the type disclosed in the abovementioned prior art, are designed to minimise fluid flow disruption, they are not suited to air/fuel mixture throttle applications. This is because they do not promote mixing of the air/fuel mixture, which is important to efficient running of internal combustion piston engines.

Another type of throttle valve is shown in U.S. Pat. No. 5,662,086 (Piccinini). It describes a throttle valve that comprises a tubular elastic material mounted in the main air/fuel intake duct of an engine. Tubular elastic material is transversely acted upon by at least one pair of movable blades choking the elastic material in a perpendicular direction relative to the axis, thereby forming a constriction and throttling action. Like the above mentioned slide throttle valve, this type of throttle forms an unobstructed “full open” throttle condition, but disadvantageously sacrifices space similar to both butterfly and slide valves. Furthermore, the durability of the elastic material would be questionable, especially when the vacuum pressures of an internal combustion engine are considered.

The present invention seeks to provide a throttle valve for an internal combustion piston engine that ameliorates at least some of the problems of the prior art.

### SUMMARY OF INVENTION

According to a first aspect the present invention consists in a throttle valve for an inlet of an internal combustion piston engine comprising an aperture adapted to be variably opened and closed between a first fully opened configuration and a second near closed configuration, characterised in that said aperture is variably opened and closed by a plurality of coplanar plates mounted about the periphery of said aperture and movable towards the central region of the aperture.

Preferably said first fully opened configuration and said second near closed configuration has the central region of the aperture unobstructed to axial fluid flow.

Preferably said aperture is substantially circular.

Preferably each of said plates is pivotally mounted.

Preferably the overall length of said throttle is substantially small compared to the diameter of said aperture.

Preferably each said plate is beak shaped having a concave edge and a convex edge meeting at a tip.

Preferably said concave and convex edges are substantially equal in radius of curvature.

Preferably movement of said plurality of substantially coplanar plates is actuated by an actuator ring to move said plates simutaneously.

Preferably said throttle valve is used for either air or an air/fuel mix.

Preferably said throttle valve may be used on a rotary valve internal combustion piston engine.

### BRIEF DESCRIPTION OF DRAWINGS

FIG. 1 is a cross-sectional view of a prior art butterfly throttle valve located near the inlet port of a rotary valve engine.

FIG. 2 is a cross-sectional view of a throttle valve of the present invention located near the inlet port of a rotary valve engine.

FIG. 3 is an elevational view of the throttle valve shown in FIG. 2 in a fully open configuration.

FIG. 4 is an elevational view of the throttle valve shown in FIG. 2 in a two-thirds open configuration.

FIG. 5 is an elevational view of the throttle valve shown in FIG. 2 in a one-third open configuration.

FIG. 6 is an elevational view of the throttle valve shown in FIG. 2 in a near closed configuration.

### BEST MODE OF CARRYING OUT THE INVENTION

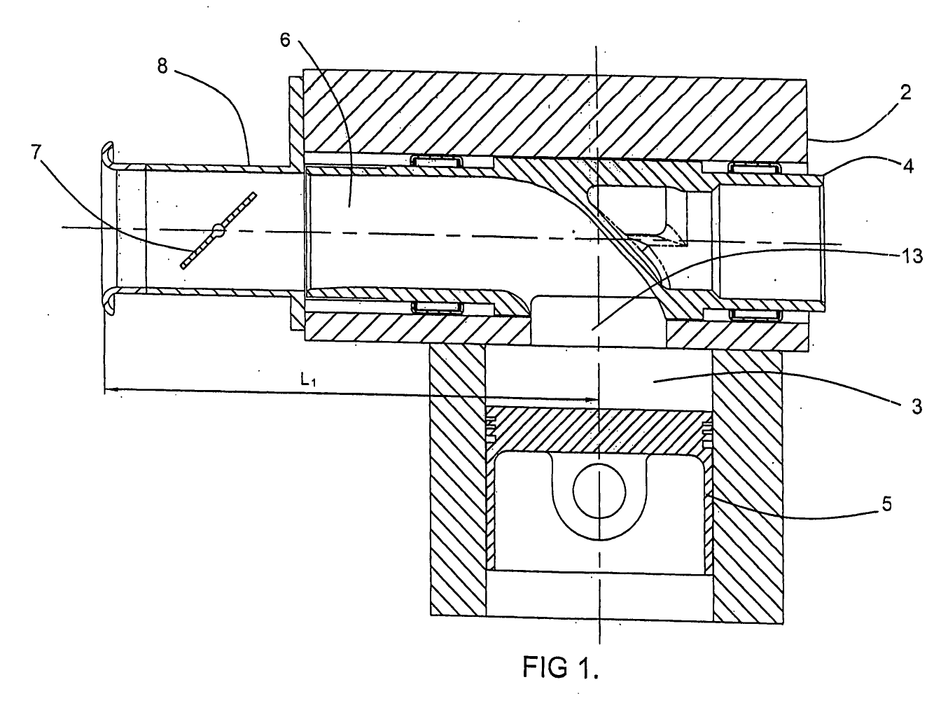

FIG. 1 depicts a prior art butterfly throttle valve 8 located on a rotary valve internal combustion piston engine comprising a cylinder head 2, cylinder bore 3, rotary valve 4 and a piston 5. Rotary valve 4 having an inlet port 6 in fluid communication with cylinder intake 13. A disadvantage associated with throttle valve 8 is that if it is located too close to the cylinder intake 13, the fluid flow may be misdirected by butterfly plate 7, and thereby impede efficient combustion of the air/fuel mix in cylinder bore 3.

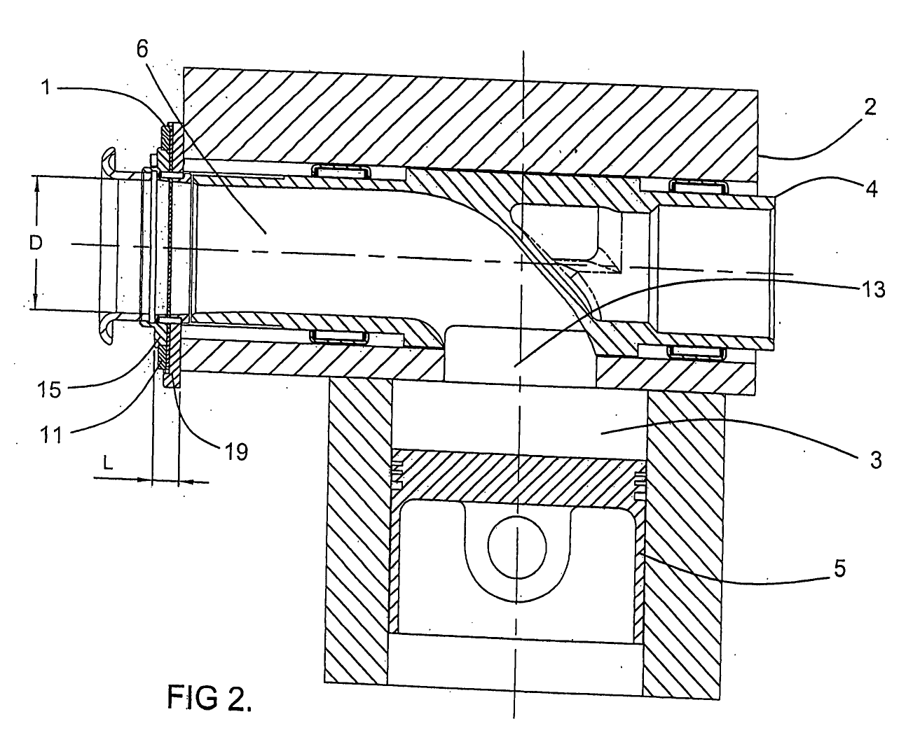

FIG. 2 depicts a throttle valve 1, located on a single cylinder rotary valve internal combustion piston engine comprising a cylinder head 2, cylinder bore 3, rotary valve 4 and piston 5. Rotary valve 4 having an inlet port 6 in fluid communication with cylinder intake 13. Throttle valve 1 allows fuel/air mix into the cylinder bore (combustion chamber) 3 subject to the angular position of rotary valve 4.

Throttle valve 1 is mounted to inlet port 6 utilising a flange mounting means (not shown). The length L of throttle valve 1 is substantially smaller than the valve aperture diameter D. As length L is small relative to diameter D, it minimises the distance between cylinder intake 13 and the air intake opening (not shown).

FIGS. 3-6 show throttle valve 1 in four different opening configurations, “fully opened”, “two-thirds open”, “one-third open” and “near closed”. Throttle valve 1 has six coplanar “beak shaped” plates 10 disposed about the outside of the periphery of circular aperture 9. Each plate 10 has a tip 19, a concave edge 20, and a convex edge 21. The radius of curvature of each concave edge 20 and convex edge 21 is substantially equal to the radius of curvature of the periphery of circular aperture 9.

Each plate 10 is pivotally mounted about a respective fixed pin 14. The fixed pins 14 are circumferentially equally spaced apart and mounted to an annular mounting plate 15.

Each plate 10 has an arcuate slot 16 and short straight slot 17 and is constrained to pivotal movement about its respective fixed pin 14, with its arcuate slot 17 constraining the magnitude of rotation.

An actuator ring 11 has six actuator pins 18 fixed thereto and are circumferentially equally spaced apart to each other. Each actuator pin 18 is engaged with a respective straight slot 17 of a plate 10. Rotational movement of actuator ring 11, as shown by arrow A, simultaneously moves all six plates 10 about their respective fixed pins 14, such that tip 19 of each plate 10, moves inwardly into circular aperture 9 progressively closing valve 1.

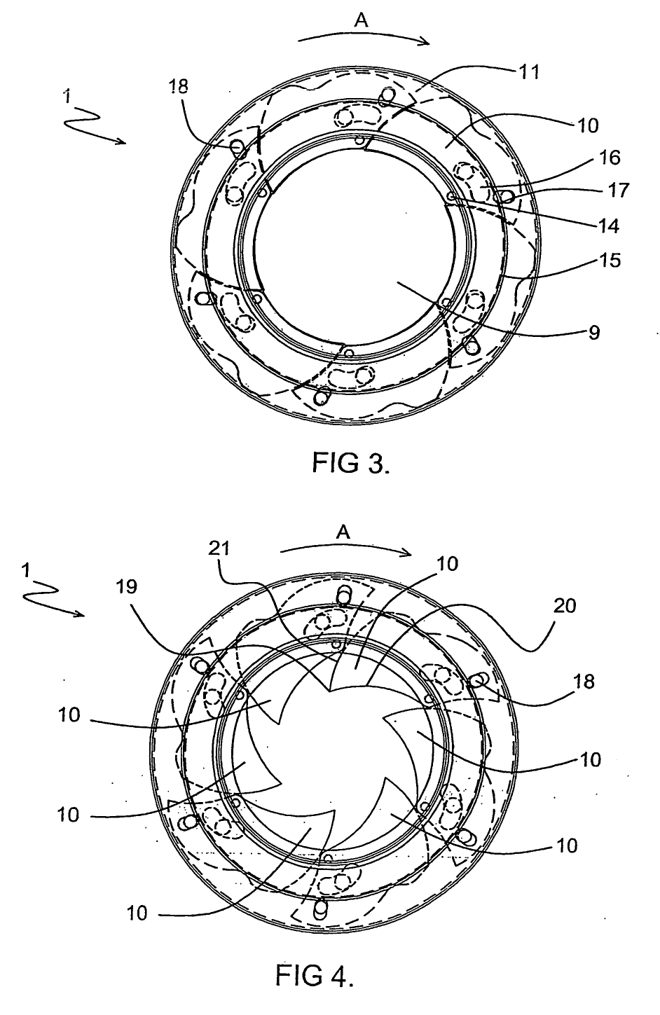

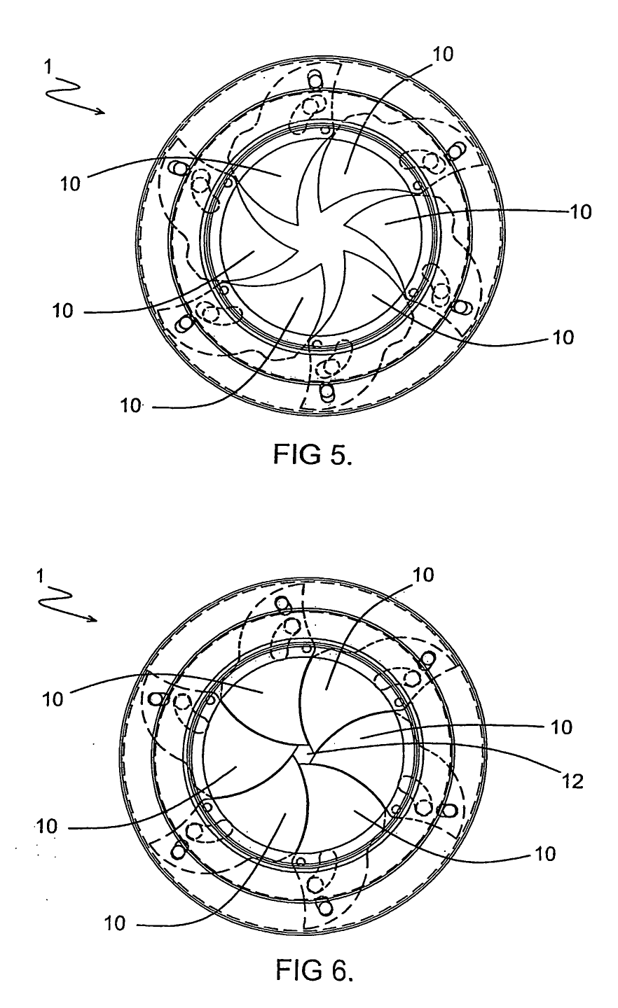

Movement of “beak shaped” plates 10 varies the state of throttle valve 1 from a “fully open configuration” (see FIG. 3) to a “near closed configuration” (see FIG. 6). In the “near closed configuration”, a small substantially hexagonally shaped unobstructed central region 12 of the aperture 9 is provided to allow enough air/fuel mix to maintain the engine at an idle state. FIG. 4 depicts valve 1 in a two-thirds open configuration, and FIG. 5 depicts valve 1 in a one-third open configuration. Alternatively, “near closed configuration” may represent a situation wherein central region 12 is minimised and the idle state is maintained by the throttle valve 1 being slightly opened, thereby allowing idle air/fuel mix flow between each of the plates 10.

Rotational movement of actuator ring 11 in a direction opposite to arrow A, will progressively open valve 1. In the fully open configuration of valve 1 as shown in FIG. 3, all six plates 10 withdraw from aperture 9 such that their respective concave edges 20 align with the outer circular periphery of aperture 9. In this fully open configuration, there is no obstruction to air/fuel flow.

An advantage of throttle valve 1 of the above described embodiment is that it provides a low obstruction, non-directed intake path that is not achievable with prior art butterfly valves, whilst promoting fuel/air mixture. It also has the advantage of compact space configuration, not achievable with prior art slide valves and that of the valve described in U.S. Pat. No. 5,662,086 (Piccinini). This makes the above-described embodiment of the present invention, advantageous for high-speed engines, such as competition engines.

Another advantage of this embodiment is that all six plates 10 are co-planar and do not overlap. As such, they are not prone to binding and seizure that occurs with conventional “iris diaphragm” type valves.

It should be understood that the reciprocal rotation of actuator ring 11 to variably open and close throttle valve 1, may be achieved by any suitable actuation mechanism, such as a biased mechanical cable, hydraulic or electric motorised actuator.

It should also be understood that in another not shown embodiment, plates 10 may have concave and convex edges having radii of curvature that are not substantially equal to that of the circular aperture 9. In such an embodiment plates 10 may have to withdraw past the outer periphery of the aperture 9 to allow an unobstructed “fully open configuration” of valve 1.

In the above described embodiment, the fuel delivery means is not shown. It should be understood that the fuel delivery means may deliver fuel before or after throttle valve 1. In the case of a direct injection internal combustion engine, throttle valve 1 may be used only for air.

In the embodiment where the fuel delivery means delivers fuel and air before throttle valve 1, it should be understood that tip 19, and concave and convex edges 20, 21 of each plate 10, may assist in the mixing of the fuel and air when throttle valve 1 is partly opened, such as depicted in FIGS. 4 and 5.

It should also be understood that whilst the above described embodiment of the present invention is particularly suited to use with a high speed rotary valve competition piston engine, the throttle valve of the present invention may be used with any internal combustion piston engine.

1. A throttle valve for an inlet of an internal combustion piston engine comprising an aperture adapted to be variably opened and closed between a first fully opened configuration and a second near closed configuration, characterised in that said aperture is variably opened and closed by a plurality of coplanar plates mounted about the periphery of said aperture and movable towards the central region of the aperture.

2. A throttle valve as claimed in claim 1 wherein at said first fully opened configuration and said second near closed configuration, the central region of the aperture is unobstructed to axial fluid flow and wherein said aperture is substantially circular.

3. A throttle valve as claimed in claims 1 wherein each of said plates is pivotally mounted.

4. A throttle valve as claimed in claims 1 wherein the overall length of said throttle is substantially small compared to the diameter of said aperture.

5. A throttle valve as claimed in claims 1 wherein each said plate is beak shaped having a concave edge and a convex edge meeting at a tip.

6. A throttle valve as claimed in claim 5 wherein said concave and convex edges are substantially equal in radius of curvature.

7. A throttle valve as claimed in claim 5 wherein said concave and convex edges are substantially equal in radius of curvature to that of said aperture.

8. A throttle valve as claimed in claim 1 wherein movement of said plurality of substantially coplanar plates is actuated by an actuator ring to move said plates simultaneously.

9. A throttle valve as claimed in claim 1 wherein said throttle valve is used for either an air or an air/fuel mix.

10. A throttle valve as claimed in claim 1 wherein said throttle valve may be used on a rotary valve internal combustion piston engine.
